(19) United States
(12) Patent Application Publication
(10) Pub. No.: US 2014/0165170 A1
(43) Pub. Date: Jun. 12, 2014

(54) CLIENT SIDE MOBILE AUTHENTICATION

(71) Applicant: RAWLLIN INTERNATIONAL INC., Tortola (VG)

(72) Inventors: Andrey Dmitriev, St. Petersburg (RU); Nikolas Pushkin, Sankt-Petersburg (RU)

(73) Assignee: Rawllin International Inc., Tortola (VG)

(21) Appl. No.: 13/709,688

(22) Filed: Dec. 10, 2012

(51) Int. Cl. H04L 29/06

(52) U.S. Cl. CPC H04L 63/08; H04L 63/0823
USPC 726/7

(57) ABSTRACT

Techniques to facilitate user authentication on a mobile device executed on the client side are provided. An embodiment includes a subscriber identity module device, comprising at least one memory to store computer executable components and user information representing a user identity associated with a device with a subscriber identity module interface with which the subscriber identity module device is configured to be employed. The computer executable components comprise a local server component configured to, as facilitated by a processor of the device communicatively coupled to the at least one memory, at least receive a hypertext transfer protocol request message for the user information from an application of the device over a local area network, and provide the user information to the application over the local area network using the hypertext transfer protocol in response to receipt of the hypertext transfer protocol request message.

### TECHNICAL FIELD

This disclosure relates generally to user authentication, e.g., to user authentication on a mobile device executed on the client side.

### BACKGROUND

Communication devices (e.g., wireless communication devices), such as mobile phones, electronic tablets, electronic gaming devices, and computers, are increasingly using applications to perform various functions and to communicate information between these communication devices and other communication devices (e.g., other mobile phones, electronic tablets, electronic gaming devices, computers, servers, etc.). An application can reside on a user's communication device, in a cloud, and/or on a server farm, for example. These applications often require the user of a mobile device to authenticate himself or herself prior to performing a task of the application or providing the user access to information provided by the application.

Many mobile devices include subscriber identity module (SIM) cards that securely store an International Mobile Subscriber Identity (IMSI) number and a related key used to identify and authenticate subscribers on a wireless service network. However, many of these mobile devices do not allow mobile applications to communicate directly with the SIM card on the device to retrieve the IMSI and related key. For example, these devices do not allow mobile application to interact with the SIM's application program interface (API) using application protocol data unit (APDU) commands. Therefore, it is difficult to authenticate a mobile device user on an application provider's web portal via the SIM card. As a result, the application will generally request additional input from the user, such as login and password information, in order to authenticate the user. User input of authentication information is considered an inconvenient and insecure authentication method. Further, mobile device user authentication methods generally require a mobile application to communicate with a plurality of distributed applications and devices over external operating networks to render user authentication information.

The above-described deficiencies associated with mobile device authentication are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with user authentication on a mobile device executed on the client side. For instance, an embodiment includes a subscriber identity module device, comprising at least one memory to store computer executable components and user information representing a user identity associated with a device with a subscriber identity module interface with which the subscriber identity module device is configured to be employed. The computer executable components comprise a local server component configured to, as facilitated by a processor of the device communicatively coupled to the at least one memory, at least receive a hypertext transfer protocol request message for the user information from an application of the device over a local area network, and provide the user information to the application over the local area network using the hypertext transfer protocol in response to receipt of the hypertext transfer protocol request message.

In another non-limiting embodiment, a method is provided comprising employing at least one processor to facilitate executing computer executable instructions from at least one computer readable storage device to perform operations comprising: receiving, at a local server component of a subscriber identity module card connected to a device, a hypertext transfer protocol request message from an application of the device over a local area network, the hypertext transfer protocol request message including a request for user information representing a user identity associated with the device and stored on the subscriber identity module card, and providing, by the local server component using the hypertext transfer protocol, the user information to the application over the local area network in response to the receiving the hypertext transfer protocol request message.

In yet another non-limiting embodiment, provided is a device comprising an interface that receives a subscriber identity module card storing user information representing a user identity associated with a user of the device and comprising a local server component configured to provide the information over a local area network using hypertext transfer protocol. The device further includes a memory having computer executable components stored thereon, and configured to store information associated with a user of a device in which the integrated circuit card is employed, the information comprising private information associated with the user, and a processor communicatively coupled to the memory, the processor configured to facilitate execution of the computer executable components, the computer executable components, comprising: a browser configured to access data using hypertext transfer protocol, and an application configured to employ the browser to receive the user information from the local server component over the local area network.

Still another non-limiting embodiment provides a tangible computer-readable storage medium comprising computer-readable instructions that, in response to execution, cause a computing system to perform operations, comprising: sending, by an application of a device, a request for information representing a user identity associated with a user of the device and stored on a subscriber identity module card communicatively coupled to the device, wherein the sending includes sending the request formatted using hypertext transfer protocol over a local area network, and receiving the user information at the application over the local area network.

Other embodiments and various non-limiting examples, scenarios and implementations are described in more detail below. The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 illustrates a block diagram of an example system for accessing private user information stored at a SIM device when the SIM device is employed with another device, in accordance with various aspects and embodiments described herein.

FIG. 2 illustrates a block diagram of an example system for locally authenticating a user by an application of a device with user authentication information stored at a SIM device employed with the device, in accordance with various aspects and embodiments described herein.

FIG. 3 illustrates a block diagram of an example system for communicating information between devices over a personal area network (PAN) in association with local authentication by one of the devices, in accordance with various aspects and embodiments described herein.

FIG. 4 illustrates a block diagram of another example system for communicating information between devices over a PAN in association with local authentication by one of the devices, in accordance with various aspects and embodiments described herein.

FIG. 5 presents a diagram of a local mobile device authentication process in accordance with various aspects and embodiments of the disclosed subject matter.

FIG. 6 is a flow diagram of an example method for retrieving, over a local area network (LAN), user authentication information from a SIM card communicatively coupled to a device using an application of the device, in accordance with an aspect of the disclosed subject matter.

FIG. 7 is a flow diagram of an example method for retrieving, over a LAN, private user information from a SIM card communicatively coupled to a device using an application of the device, in accordance with an aspect of the disclosed subject matter.

FIG. 8 is a flow diagram of an example method for retrieving, over a LAN, private user information from a SIM card communicatively coupled to a device using an application of the device, in accordance with an aspect of the disclosed subject matter.

FIG. 9 is a flow diagram of an example method for communicating information between devices over a PAN in association with local authentication by one of the devices, in accordance with an aspect of the disclosed subject matter.

FIG. 10 is a schematic block diagram illustrating a suitable operating environment in accordance with various aspects and embodiments.

FIG. 11 is a schematic block diagram of a sample-computing environment in accordance with various aspects and embodiments.

### DETAILED DESCRIPTION

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

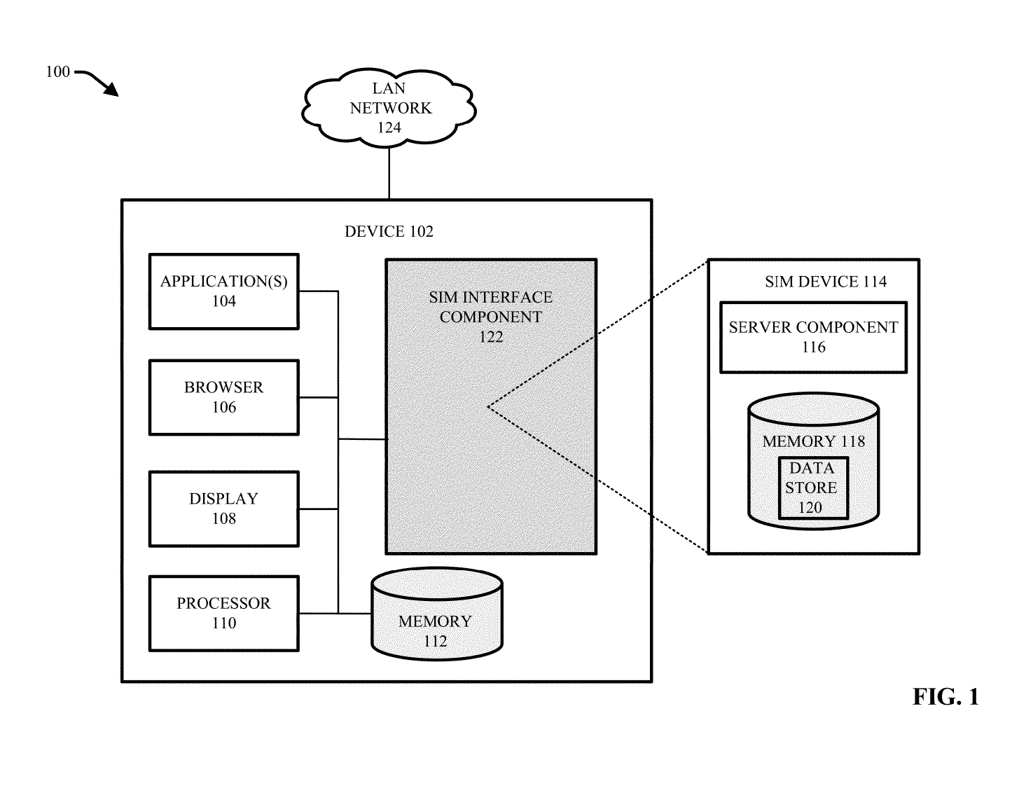

Referring now to the drawings, with reference initially to FIG. 1, presented is a system 100 for accessing private user account information over a local area network (LAN). System 100 includes a device 102 and a subscriber identity module (SIM) device 114, wherein the SIM device 114 is configured to insert into device 102 and facilitate various operations of device 102. Aspects of apparatuses, systems or processes explained herein can constitute machine-executable components embodied within machine(s), e.g., embodied in one or more computer readable mediums (or media) associated with one or more machines. Such components, when executed by the one or more machines, e.g., computer(s), computing device(s), virtual machine(s), etc. can cause the machine(s) to perform the operations described.

In an aspect, device 102 includes memory 112 for storing computer executable components and instructions. The device 102 further includes a processor 110 to facilitate operation of the computer executable components and instructions by the device 102. In an aspect, SIM device 114 includes memory 118 for storing information, including computer executable components and instructions associated with the SIM device 114. SIM device 114 is configured to insert into device 114 via SIM interface component 122. Upon insertion, the SIM device becomes communicatively coupled to one or more of the components of device 102. In an aspect, when inserted into device 102, the SIM device employs processor 110 to facilitate operation of the computer executable components and instructions of the SIM device 114 stored in memory 118.

It should be appreciated that in system 100, the device 102 and SIM device 114 are shown separated for exemplary purposes. The novel operations of system 100 become exemplified when the device 102 and SIM device 114 are connected to one another. Accordingly various aspects of system 100 are described with the assumption that SIM device 110 is inserted into device 102 via SIM interface component 122.

A SIM device, such as device 114, is device having an integrated circuit embedded onto a card (e.g., a plastic card). In an aspect, SIM device 114 is interchangeable amongst a plurality of devices. In general, SIM devices used in mobile telephones securely store an International Mobile Subscriber Identity (IMSI) number and a related key used to identify and authenticate subscribers on a cellular service network. Accordingly, in some embodiments, the SIM device 114 can include the IMSI and a related key in memory 112. The integrated circuit of SIM device 114 however at least includes server component 116 and memory 118.

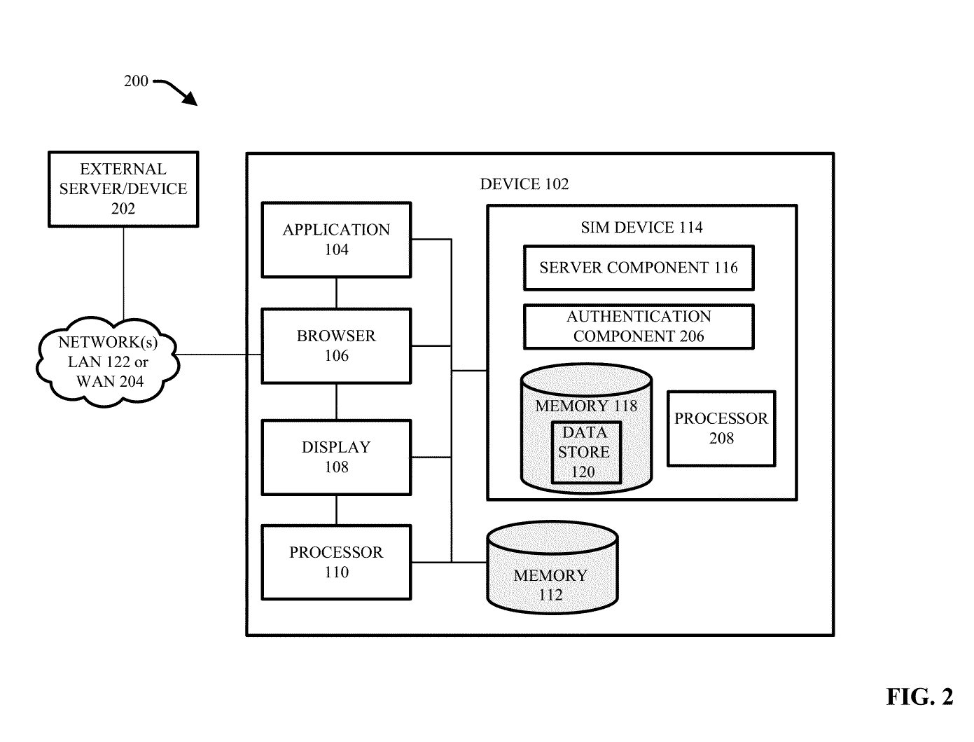

In addition to computer executable components and instructions, memory 118 can further include data store 120 for storing private user information associated with a user of a device in which the SIM device 114 is to be employed (e.g., device 102). The private user information can represent a user identity associated with a user of a device (e.g., device 102) in which the SIM device 114 is configured to be employed. In an aspect, this private user information can include user account information. As used herein the term user account refers to an account having personal or private information about an account representing a user of device 102. For example, a user account can include a user's cellular service plan, a user's personal profile, or a user's financial account. Accordingly, user account information stored in data store can include information defining a user's cellular service plan, usage history, payment requirements, payment history and etc. In another aspect, user account information can define an individual's financial account history, balance history, payee designations, automatic payment plan features, and etc. In another aspect, as discussed in greater detail infra with respect to FIG. 2, the private information held in data store 120 can include user authorization information.

In an aspect, server component 116 is configured to deliver content stored in data store 120 to an application 104 at the request of the application using hypertext transfer protocol (HTTP) and over a local area network (LAN) 124. Server component can further receive content from an application formatted using HTTP. Therefore, server component 116 is configured to process HTTP POST and GET requests send by an application of the device 102. In this respect, server component 116 functions as an internal web server employing the LAN 124. As a result applications of device 102 can retrieve private information online without contacting external servers and/or without employing dedicated channels of a wireless network provider servicing device 102 (e.g., a cellular service provider.

For example, server component 116 can receive a HTTP formatted request from an application 104 via the LAN for private user account information stored in data store 120. As discussed below, the application 104 can retrieve and view information provided by the server component 116 using a browser 106 of the device 102. In response to the request, the server component 116 can retrieve the user account information and send it back to the application over the LAN 124 formatted using HTTP. In response to receipt of the account information, the server component 116 can further provide the account information to the application (e.g., within a browser 106) in a format that allows a user to interact with and modify the account information. For example, the server component 116 can display (e.g., via display 108) dynamic user profile and/or account information, allow a user to manage account information, inquire about an account balance, change phone plan, inquire about account expenditures, and etc. The server component 116 can also receive information from the application 104, such as a modification to account information, formatted using HTTP and sent over the LAN. For example, a user can select an upgrade to a cellular service plan when examining her cellular service account information. Upon receipt of the modification to the account information, the server component 116 can effectuate the modification to the account information in data store 120. In furtherance to the example above, the features associated with the upgrade will become effective upon sending the modification to the server component 116.

By employing server component 116 of SIM device 114 (when inserted into device 102), a device application 104 can request private user information and receive the user private information online using the LAN 124 via HTTP without incurring any additional fees associated with usage of a dedicated provider's channel. As a result, the client 102 can view and manage account information without incurring additional fees associated with usage of the provider's network. The client device can further access the server component 116 using a standard browser 106 installed on the device. Additionally, the client can more efficiently access and manage account information using the direct link (e.g., via LAN 124) to the account information physically located within the device via the inserted SIM device. Further, because the user's account information is stored on the SIM device, the information is better protected from misappropriation by hackers and the like.

The local area network, LAN 124, can include a computer network that interconnects computers in a limited geographic area (e.g., a home, a school, a computer laboratory, or an office building). The defining characteristics a LAN, in contrast to a wide area network (WAN), include a usually higher data-transfer rate, a smaller geographic area, and lack of a need for leased telecommunication lines. In an aspect, the LAN is a wireless local area network (WLAN), such as a Wi-Fi network or a Wi-Max network.

Device 102 can include any suitable computing device at least configured to communicate with a SIM device 114 over the LAN 124. In an aspect, device 102 is a mobile device such as a cellular phone or smartphone (e.g., a 3GPP or 4GPP Universal Mobile Telecommunications System (UMTS) phone). Device 102 can further include but is not limited to, an electronic notebook, an electronic pad or tablet, an electronic gaming device, a personal digital assistant (PDA), a computer, or a set-top box, that can operate and communicate in a communication network environment.

In an aspect, in addition to an ability to communicate with the SIM device 114 over the LAN, device 102 is configured to communicate with various devices, servers, and applications wirelessly using virtually any desired wireless technology, including, for example, cellular, WAN, Wi-Fi, Wi-Max, and WLAN, etc. For example, in an aspect, device 102 is a cellular phone. As the cellular phone moves through a wireless communication network environment, at various times, the device 102 can be connected (e.g., wirelessly connected) to one of a plurality of access points (APs), (e.g., macro or cellular AP, femto AP, pico AP, Wi-Fi AP, Wi-Max AP, hotspot (e.g., Hotspot 1.x, Hotspot 2.x, where x is an integer number; etc.), etc.), that can operate in a wireless communication network environment.

In addition to processor 110 and memory 112, device 102 can include one or more applications 104, a browser 106, a display 108, and SIM interface component 122. The SIM interface component 122 can include a physical slot or area of device 102 having a size and shape for receiving the SIM device 114 and including means for interfacing with the SIM device. In particular, the SIM interface component can include means for electrically coupling one or more hardware components of device 102 to the integrated circuit of the SIM device 114.

Browser 106 can include a web browser configured to enable device 102 access to information provided by a web server. In an aspect, browser 106 includes a standard software application available for retrieving, presenting and traversing information resources on the World Wide Web (e.g., the Internet), (e.g., Chrome™, Firefox™, Internet Explorer™, Opera™, and Safari™). In addition, browser 106 can be used to access, present, and traverse information provided by server component 116. In particular, browser 106 can be used to retrieve and display private user information held in data store 120 over the LAN 124. Display 108 can include any suitable display screen configured to display data to a user of device 102. For example, display 108 can include but is not limited to, a vacuum fluorescent display (VFD), a light emitting diode display (LED), a cathode ray tube (CRT) (Monoscope), a liquid crystal display (LCD) (TFT •LED •Blue Phase •IPS), a plasma display panel (PDP) (ALiS), a digital light processing (DLP), or a liquid crystal on silicon display (LCoS).

The one or more applications 104 of device 102 can include a variety of computer software programs designed to perform a specific task. The one or more applications 104 reside on device 102 and operate in part based on access to private information stored on SIM device 114. For example, the one or more applications 104 can include applications pre-installed on device 102 during manufacture, applications downloaded to device 102 from various mobile software distribution platforms, or applications delivered as a world wide web (web) application using server-side or client-side processing (e.g., JavaScript™) to provide an application experience within browser (e.g., a web browser) at device 102. Regardless of the type of application, the one or more applications 104 are configured to access private information stored on SIM device 114 LAN 124 using browser 106.

In an aspect, the one or more applications 104 include applications configured to run on device 102 without communication to an external server and/or communication to an external server via a dedicated channel associated with a cellular network provider (e.g., where device 102 is configured to communicate with a cellular network). For example, the one or more applications 104 can include an application that that facilitates user account management where the user account information is held on SIM device 104 and accessed by the application 104 using browser 106 over LAN 124. According to this example, a user of device 102 can employ the application to retrieve and/or manage account information stored on SIM device 104.

In another aspect, the one or more applications can include applications configured to communicate with a remote external server over a network (e.g., a cellular network, a wide area network (WAD), or a LAN). According to this aspect, the one or more applications 104 can include an application that requests private information associated with a user of device 102 prior to receiving access to the external server for performing the operations of the application. For example, as discussed further with respect to FIG. 2, the one or more applications can include an application that requires user authorization information, such as a private key or digital signature associated with the user, prior to providing the full services of the application.

Referring now to FIG. 2, presented is a system 200 for accessing private user authorization information located on a SIM device inserted into a device using an application of the device, over a LAN. System 200 is depicted having SIM device 114 inserted into device 102, however, it should be appreciated that SIM device 114 is removable from device 102. Repetitive description of like elements employed in respective embodiments of devices and SIM devices described herein are omitted for sake of brevity.

In system 200, SIM device 114 further includes authentication component 206 and processor 208. As noted supra, in an aspect, when inserted into device 102, the SIM device 114 can employ processor 110 to facilitate operation of the computer executable components and instructions of the SIM device 114 stored in memory 118. In another aspect, the SIM device 114 can include an internal processor 208 to facilitate operation of some or all of the computer executable components and instructions of the SIM device 114 stored in memory 118.

Also as noted above, data store 120 can hold information representing a user identity of a device in which the SIM device is configured to be employed (e.g., device 102). In an aspect, this information includes user authentication information that and can be used to authenticate a user (e.g., by an application 104 of device 102 or by an application of another device) and/or to electronically sign data (e.g., data employed by an application of device 102 or by an application of another device). For example, the authentication information can be used to authorize a user access to an external server or device 202 via an application 104 on device 102, where the application 104 is serviced by the by a system at the external server/device 202 over an external network. The external network can include any suitable wireless communication network communication network (e.g., a cellular network, a WAN 122, or a LAN 204). In another example, the authentication information can be used to electronically sign a contract associated with an operation of an application 104 of device 102.

In an embodiment, the server component 120 is configured to receive a request from an application 104 on device 102 to authenticate a user and/or electrically sign data using a user's authentication information stored in data store 120. For example, the device application 104 can provide the device access to an external device or server 202 in response to receiving the authentication information. The authentication component 206 is configured to facilitate retrieval of user authentication information at the request of server component 116.

In particular, an application is 104 is configured to send a request for user authorization information to the server component 116 in association with authorizing a user of device 102 or employing the information to digitally sign data with an electronic signature of the user of device 102. The request is sent by the application using browser 106 to the server component 116 formatted using HTTP and over the LAN 124. The sever component 116 is configured to process HTTP GET and POST requests associated with retrieving private user information on the SIM device 114. When the information requested is user authorization information, the server component 116 transfers the HTTP GET and POST requests to the authentication component 206. In response to receipt of a request from the server component 116 for user authentication information, the authentication component 206 securely retrieves the authentication information and provides it to the server component 116 for delivery to the requesting application 104 using HTTP over the LAN. In turn, the requesting application 104 can employ the data to locally authenticate the user and/or to electrically sign data using a user's digital certificate or private key.

As noted above, SIM devices, such a SIM device 114, generally include an IMSI and a related key used to identify and authenticate subscribers on a cellular service network. However, many mobile devices do not allow mobile applications to communicate directly with the SIM card on the device to retrieve the IMSI and related key (e.g., many mobile applications do not interact with the SIM's application program interface (API) using application protocol data unit (APDU) commands). Further, mobile device user authentication systems generally require communication between a plurality of applications and devices over an external operating networks to render authentication information, regardless as to where the authentication information is stored. Such distribution of authentication elements is generally implemented to enhance the security of the system.

By employing server component 116 in conjunction with authentication component 206, SIM device 114 enables the storage of authentication data on the SIM device and the direct retrieval (e.g., via a direct link between the application and server component 116 via the LAN) of the authentication data from the SIM device 114 by an application 104 of the device. As a result, device applications 104 do not need to communicate with external application providers and/or outside networks in order to perform authentication of a user or to digitally sign data with a digital certificate of the user.

User authentication information held in data store 120 can include a variety of information that uniquely identifies a user of the device in which SIM device 114 is employed. In an aspect, the user authentication information includes a digital certificate assigned to a user. In another aspect, the user authentication information includes private keys associated with a public key infrastructure (PKI). In particular, the user authentication information can include a secret or private key associated with a user and required for user authorization in association with the public key. Still in other aspects, the user authentication information can include but is not limited to, a personal identification number (PIN), a password, a series of passwords, or bio-recognition information. In various aspects, user authentication information can include user identification information and vice versa.

In an embodiment, the authentication component 206 employs a public key infrastructure (PKI) interface to facilitate providing user authorization information in response to a request for the user authorization information. According to this aspect, the authentication component 206, functions as a secure signature creation device (SSCD) for the creation of a digital signature for user of device 102. PKI is a standard basis for digital signatures (e.g., standard electronic signatures). PKI provides each parting in an authentication agreement with a pair of keys, a private key, and a public key, used in every signed transaction. The private key, as the name implies, is not shared and is used only by the signer (e.g., the user of device 102 in which the SIM device 114 is employed) to electronically sign documents. The public key is openly available and used by the entity that needs to validate the signer's electronic signature (e.g., the application 104 and/or an application server associated with an external server employed by application 104). In an aspect, data store 120 store's the private key for a user, and the authentication component 206 renders the private key in order to authorize a user in response to a request to authorize the user.

In an example embodiment, the server component 116 receives, via LAN 124, a HTTP request for authentication information by an application 104 of device 102. For example, the request can include a request to receive information verifying a user's identity, such as a private key or a personal identification number (PIN) code. As used herein, a request to verify a user's identity or verify that a user is in fact a human and not a machine, is referred to as a challenge request. In another aspect, the request can include a request to sign data with a digital certificate or private key. As used herein, a request to sign data using a digital certificate or private key is referred to as a sign request. In an aspect, with a sign request, the server component 116 receives a request to sign data and the data to be signed. In response to receipt of a challenge request or a sign request, the server component 116 transfers the request (and associated data when the request is a sign request) to the authentication component 206.

Depending on the type of request (e.g., challenge request or sign request), the authentication component 206 can perform various acts in response to receipt of the request. In an aspect, the authentication component 206 merely retrieves the requested authentication information from data store 120 and provides it to the server component 116. In turn the server component sends the authentication information back to the requesting application via the LAN using HTTP. For example, the authentication component 206 can be configured to receive an HTTP sign request message from the server component 116 to sign data provided with the request using an electronic key or digital certificate stored in data store 120. In response to receipt of the request, the authentication component 206 can attach the electronic key and/or digital certificate to the data and send the signed data back to the server component 116. Upon receipt of the signed data, the server component 116 can send the signed data back to the requesting application via the LAN using HTTP.

In another aspect, the authentication component 206 can request user verification/identification information in response to a received challenge request. According to this aspect, the authentication component 206 can receive a challenge request to verify the identity of a user and return information as a challenge response that indicates an identity of a user. For example, the authentication component 206 can return a password, a PIN, or a private key for a user stored in the data store 120 that verifies the identity of a user.

In an aspect, challenge requests can prompt the authentication component 206 to require user input of identification information prior to providing user authorization information to the server component 116 for delivery to the requesting application 104. For example, the authentication component 206 can receive a challenge request to verify the identity of a user prior to providing an application with the user's private key and/or digital certificate, or prior to returning data signed with a private key. According to this example, the authentication component 206 can receive a request that includes a challenge request or a challenge request in association with a sign request. In response to a received challenge request or challenge/sign request, the authentication component 206 can generate a request for input of user identification information (e.g., via the display 108).

For example, the authentication component 206 can generate a request for user input of a personal identification number (PIN). In another example, the challenge request can include a request for a password or input of text characters by a user to verify that the user (and not a computer program/hacker) is responding to an application's authentication request. Accordingly, the authentication component 206 can generate a request for user input of the password or text characters. The request for the user input can appear on the display screen 108 of device 102 in a dialogue box that allows for user to input the requested information. In an aspect, the generated user input request dialogue box is associated with the application 104. In another aspect, the generated user input request dialogue box is independent of the application 104. Accordingly, the authentication component 206 can request and receive user identification information from a user directly (e.g., without employing the application via the server component 116 over the LAN). For example, the authentication component 206 can request input of user identification information using existing SIM toolkit standard methods.

In response to a request for user identification information, a user can input the requested information into the request dialogue box (e.g., the user can input his or her PIN code or password or type the presented characters to verify the user is present). In an aspect, the requested user identification information includes biometric information for the user. For example, the user identification information can include a fingerprint or a retinal scan. According to this aspect, rather than inputting a PIN number, a user can provide his fingerprint to device 102 (e.g., via fingerprint scanning device associated with device 102, not shown), or enable device 102 to take a retinal scan (e.g., via a retinal scanning device associated with device 102, not shown). The received biometric information can then be used as input personal identification information. In another aspect, the user identification information can include a facial picture of the user. For example, the request for user identification information by the authentication component 206 can include a request that the user take a picture of himself or herself. The picture can then be employed as user identification information by the authentication component 206.

The user input identification information can be received by the authentication component 206 via a direct (e.g., wired) electrical connection between the authentication component 206 and the device 102 (e.g., using SIM toolkit standard methods). After user identification information is received by the authentication component 206, the authentication component 206 can further verify that the entered user identification information is correct. For example, a user's identification information (e.g., a user's PIN code, password, biometric information, picture and etc.) can be stored in data store 120. The authentication component can compare a received input of user identification information to the information for the user stored in data store 120. If the authentication component determines that the received input of user identification information does not match the information for the user stored in data store 120, the authentication component 206 can send an error message to the server component 116 indicating that the user's identity has not been verified.

In an aspect, if the input information matches the stored information, the authentication component 206 can send a response to the server component 116 indicating that the user's authorization has been verified. In another aspect, if the input information matches the stored information, the authentication component 206 can retrieve a user's private key or digital certificate and provide this information to the server component 116 to send to the application 104 as an indication that the user's identity has been verified. Still in yet another aspect, if the input user identification information matches the stored user identification information, the authentication component 206 can retrieve a user's private key or digital certificate and attach it to data to be signed in association with a challenge/sign request. The authentication component 206 can provide the signed data to the server component 116 which in turn sends the signed data to the requesting application for use as a digitally signed document by the user. It should be appreciated that any communication of information between the server component 116 and the application 104 is carried out over the LAN using HTTP.

An application 104 is configured to employ SIM device 114 to authenticate a user and/or receive a digital signature of a user in association various aspects of the application 104 running on an external server 202 or device. In particular, application 104 can receive an authentication request from an external server/device 202 to authenticate a user. In response, the application 104 can request authentication information from server component 116 and receive the authentication information in response. In turn, the application 104 can submit a message to the external server servicing the application indicating that the user has been authenticated. In another aspect, an application 104 can receive a sign request from an external server/device 202 asking a user to digitally sign data. The application 104 can then submit a request to the server 116 to sign the data with a user's digital certificate. In an aspect, the request can include the data to be signed. The server component 116 can then return the signed data to the application and the application 104 can provide a message indicating the data has been signed . . . or submit the signed data . . . to the external server 202. As noted above, communication between the application 104 and the server 116 is performed over LAN 122 using HTTP protocol.

An external server 202 can include one or more hardware and software components operating as a system to provide a service to one or more clients. In this respect, application 104/device 102 and external server 202 can operate in a server client relationship. The one or more applications 104 and/or device 102 can be configured to communicate with an external server via any suitable communication network (e.g., a cellular network, a WAN 122, or a LAN 204).

An application 104 configured to employ the SIM device 114 for authentication purposes can include a variety of applications. For example, an application requiring user authentication can include an application that provides a user access to database comprising secure information, such as a database comprising information records for a corporation or a database requiring a user subscription for access thereof. In another example, an application requiring user authentication can include an application providing a user access to an external system for managing information collection and processing by a government agency. In another example, an application requiring a digital signature can include a money transfer application the facilitates the transfer of funds between bank accounts.

In an aspect, an application 104 configured to employ the SIM device 114 for authentication and/or digital signature purposes can authenticate a user and or sign data at device 102 without communicating user authentication information to an external server 202. For example, the application 104 itself can locally authenticate a user through use of the components of SIM device 114 (e.g., server 116, authentication component 206 and data store 120). In an aspect, in response to local authentication/signing, the application 104 can provide a user access to information available locally by the application 104. In another aspect, in response to local authentication/signing, the application 104 can provide a user (e.g., via the application 104) access to an external device or external server 202. In another aspect, in response to local authentication/signing, an application can perform a function (e.g., data transfer) using communication to an external server/device 202.

For example, application 104 can include an application that requires user authentication prior to allowing a user to communicate with an external device or external server 202. For example, application 104 can require user authentication prior to providing a user access to information provided by an external server servicing the application 104. According to this example, the external server can include an application provider for the application 104. In another example, application 104 can require a user to digitally sign data prior to allowing the application to perform an action, such as the transfer of funds or sensitive information over an external network (e.g., LAN 122 or a WAN 204). In another example, application 104 can require user authentication or a digital signing prior to allowing a user to transmit data to an external device 202 over an external network (e.g., LAN 122 or a WAN 122) via device 102. With local authentication, a user's authentication information remains protected within the SIM card. In particular, the user's authentication information is not submitted to an external device. For example, signing of data with a user's digital certificate is performed by the authentication component 206 within the SIM device 114.

However, in some aspects, an application 104 can communicate user authentication information to an external server 202. For example, the application 104 can provide electronically signed documents to an external server and/or provide user private keys or passwords to the external server for processing thereof.

In summary, in system 200, the SIM device 114 functions as a security element whereby user authentication can be achieved entirely at the client side (e.g., at the device 102) without communication to an outside network or server (e.g., to retrieve authentication information and/or to authenticate a user or generate a digital signature). One advantage of system 200, wherein the SIM device 114 is a security element, is the ability to store private keys securely in the security element by the use of the PKI API. In addition, the authentication component 206 effectuates signing of data (e.g., with a digital certificate or private key) within the SIM device 114. Since the signing is done inside the security element, the private key or digital certificate never leaves the security element. Further, by providing user authentication information on a removable SIM device 114, the user authentication information is easily portable between multiple devices.

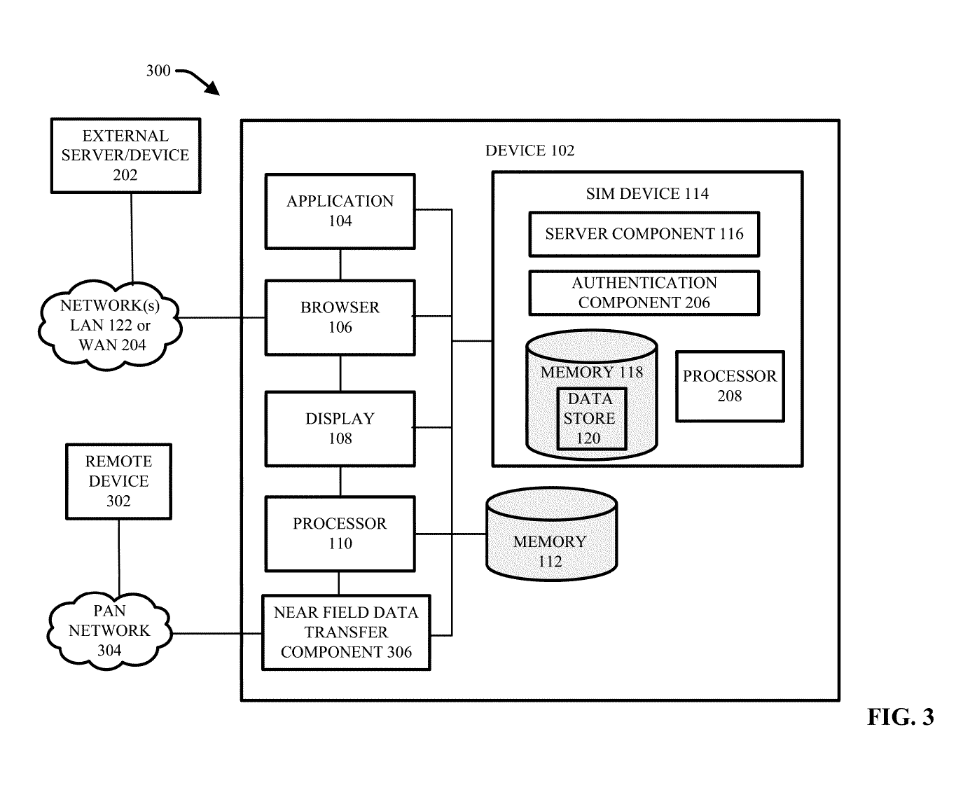

Referring now to FIG. 3, presented is a system 300 for transferring data between devices over a personal area network (PAN) in association with authenticating a user. System 300 is depicted having SIM device 114 inserted into device 102, however, it should be appreciated that SIM device 114 is removable from device 102. Repetitive description of like elements employed in respective embodiments of devices and SIM devices described herein are omitted for sake of brevity.

In system 300, device 102 includes a near field data transfer (NFDT) component 304. The NFDT is component is configured to transfer data between device 102 and a remote device 302 using a PAN 304. In an aspect, the NFDT component is configured to transfer data from a remote device 302 to the SIM device 114 and/or transfer data from the SIM device 114 to the remote device 302, at least in part using PAN 304. The NFDT component includes a transceiver (not shown), such as a radio frequency transceiver, to facilitate communication of information between device 102 and device 302. The term PAN is used herein to describe a personal communication network established between devices using short range radio communications. The PAN 304 may adopt various short-range communication protocols or standards.

In an aspect, the PAN employs a near field communication (NFC) protocol. NFC is a set of standards for smartphones and similar devices to establish radio communication with each other by touching them together or bringing them into close proximity. In particular, NFC includes a set of short-range wireless technologies, typically requiring a distance of 4 cm or less. NFC operates at 13.56 MHz on ISO/IEC 18000-3 air interface and at rates ranging from 106 kbit/s to 424 kbit/s. NFC can involve an initiator and a target; the initiator actively generates an RF field that can power a passive target. This enables NFC targets to take very simple form factors such as tags, stickers, key fobs, or cards that do not require batteries. In an aspect, remote device 302 is configured to serve as a target while device 102 is configured to serve as an initiator. In another aspect, NFC peer-to-peer communication is possible, provided both devices 304 and 102 are powered. According to this aspect, the remote device 302 can serve as an initiator or a target, depending on the direction of data transfer.

In other aspects, the PAN can employ short range communication protocol including but not limited to, Bluetooth™ technology, IrDA (Infrared Data Association) specification, ultra-wideband (UWB) standard, and etc. For example, the PAN may be implemented using Bluetooth™ technology, where the PAN includes a master device and a slave device. Device 102 can serve as a master device and device 302 can serve as a slave device, and vice versa. The range of a PAN employing Bluetooth™ technology is typically a few meters. Thus, an electronic device in the PAN may be communicatively decoupled from the PAN if the electronic device is physically moved away from the master device of the PAN beyond a predetermined distance.

In an embodiment, the NFDT component is configured to transfer data from device 102 to device 302 in response to authentication of a user of device 102 by an application 104 of the device. According to this embodiment, an application 104 can authenticate a user in the various manners discussed herein using the authentication information stored on the SIM device 114. For example, an application 104 can include an application that facilitates transfer of money from an account associated with a user of device 102 to an account associated with a user of device 302. According to this aspect, the application 104 can require a user of device 102 to authenticate himself or to digitally sign data authorizing a transaction prior to the transfer of funds via NFDT component 306. According to this aspect the application 104 and the NFDT component 306 can work together. The application 104 can request user authentication information from the SIM device 114 and authenticate a user in the manner's discussed herein. In response to authentication, the application 104 can employ the NFDT component 306 to securely transfer data (e.g., payment information) to device 302 over the PAN 304.

In another embodiment, the NFDT component 306 facilitates transfer of information on the SIM device to another device 302 and vice/versa. In an aspect, the NFDT component 304 acts in a manner similar to application 104 when communicating with the SIM device 114. In particular, the NFDT component 306 can send a request for private information from the SIM device 114 and/or provide private information to the SIM device as using HTTP over the LAN. For example, the NFDT component 306 can request and receive user authentication information from the SIM device 114 in the same fashion as an application 104 (e.g., using a browser to request and receive information using HTTP over the LAN). In another aspect, the NFDT component 306 can communicate information to and from the SIM device 114 directly (e.g., via a wired or other physical electrical connection between the NFDT component and the SIM device 114). After the NFDT component 306 receives information from the SIM device 114 (e.g., user authentication information and/or user account information), the NFDT component 306 can transfer the information to another device, such as device 302 using over the PAN 304 (e.g., using NFC).

In an aspect, remote device 302 can provide information to device 102 over the PAN that can be employed by the authentication component 206 in association with authenticating a user by an application 104. In particular, remote device 302 can include personal user identification information that can be employed to answer a challenge request by the authentication component. According to this embodiment, the authentication component 206 can request input of personal identification information that is stored on device 302 in association with a challenge request. The remote device 302 can transmit the personal user identification information to the NFDT component 306 over the PAN 304 and the NFDT component 306 can provide the received information to the authentication component 206 as an answer to the challenge request. The data store 120 can further store the same user identification information stored on remote device 302 so that the authentication component 206 can compare the information received from the remote device with the correct information identifying the user stored by the SIM device.

For example, the remote device 302 can include a NFC tag or thumbstick configured to serve as a target and transfer information to the NFDT component 306 using NFC. The remote device 302 can however include any device capable of transferring information to the NFDT. NFC tags/thumbsticks contain transferable data and are typically read-only, but may be rewriteable. They can be custom-encoded by their manufacturers or use the specifications provided by the NFC Forum, an industry association charged with promoting the technology and setting key standards. NFC tags can securely store personal data such as debit and credit card information, loyalty program data, PINs and networking contacts, among other information. According to this embodiment, the NFC tag device 302 includes user identification information, such as passwords, PINs, registration numbers, and/or other types of information identifying a user that can be employed to answer a challenge request by authentication component 206.

In another aspect, the NFDT component 306 can transfer private user information stored in the SIM device 114 to another device 302. According to aspect, another device 302 or an application of another device can request user authorization information from device 102 to perform a task. For example, an application of another device 302 can request a user's digital signature prior to receiving a transfer of information from device 102 to device 302. The digital signature can serve as a way of informing device 302 that device 102 approves the transaction. According to this example, the NFDT component 306 can receive a request from device 302 for a user's authentication information (or other private information stored on the SIM device 114). In response to the request, the NFDT component 306 can securely communicate with the SIM device 114 to extract the requested user information. In an aspect, in order to securely extract the requested information, the NFDT component 306 can behave in a manner similar to an application 104. In particular, the NFDT component 306 can employ browser 106 to send a request for the private user information to server component 116 using HTTP over the LAN 122. The sever component can then employ authentication component 206 to gather the information from the data store 120. The NFTD component 306 can further receive the requested private user information from the server component 116 over the LAN using HTTP. Once received, the NFDT component 306 can transfer the private user information to the requesting device 302 over the PAN 304 (e.g., using NFC).

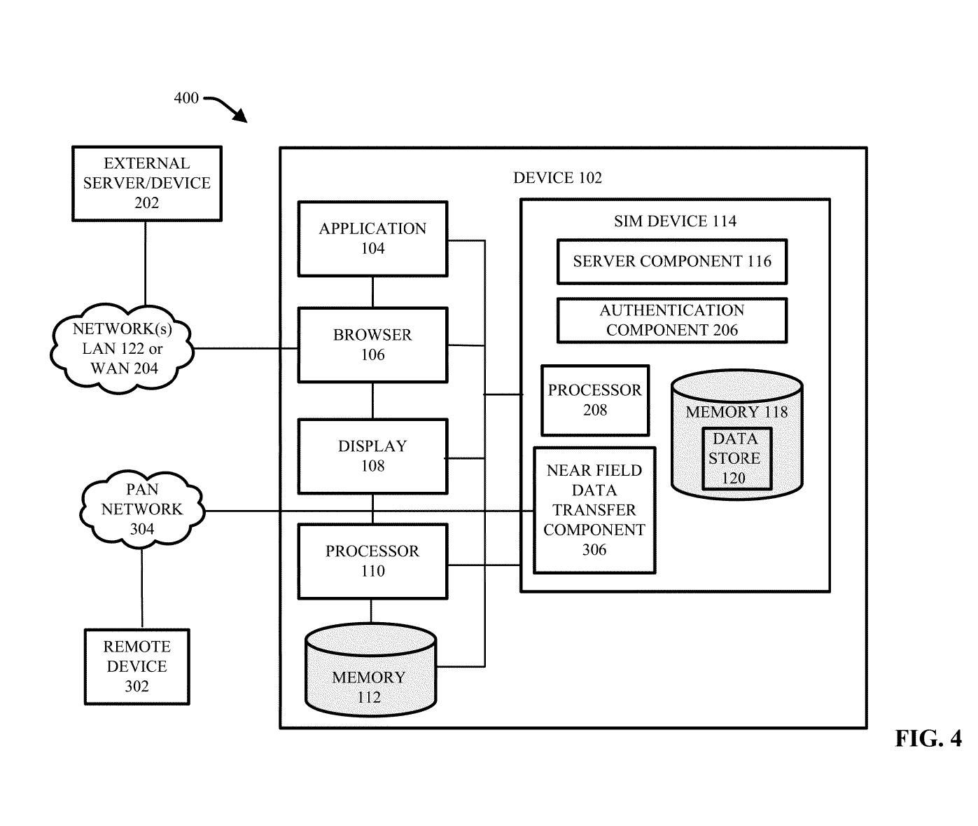

FIG. 4 presents another embodiment of a system 400 for transferring data between devices over a personal area network (PAN) in association with authenticating a user. System 400 is depicted having SIM device 114 inserted into device 102, however, it should be appreciated that SIM device 114 is removable from device 102. Repetitive description of like elements employed in respective embodiments of devices and SIM devices described herein are omitted for sake of brevity.

System 400 is analogous to system 300 with the exception that NFTD component is located on the SIM device as opposed to device 102. The NFTD component 306 includes a transceiver for transferring information to and from the SIM device 114. In one aspect, the NFDT component can receive user identification information from a remote device 302 over the PAN (e.g., using NFC). The NFDT component 306 can further provide the received user identification information to the authentication component 206 to fulfill a challenge request. For example, the authentication component can generate a prompt user identification information in association with a challenge request. The user can provide the requested information by employing a thumbstick device, such as device 302. According to this example, the user can bring the thubmstick device 302 within close range (e.g., a few centimeters when NFC is employed) of device 102, causing the requested data to transfer from device 302 to the NFDT component 306 of SIM device 114. The NFDT component 306 can then provided the received user identification information to the authentication component 206 to fulfill the challenge request.

In another aspect, an application 104 can receive a request to transfer private user information from SIM device 114 to remote device 302. The application can transmit the request to the server component 116 using HTTP via the LAN. In response to the received request, the server component can instruct the authorization component to extract the information from data store 120 in the manner described herein. However rather than sending the requested information back to the application over the LAN, the server component 116 can instruct the NFDT component to transfer the information to the remote device 302 over the PAN (e.g., using NFC).

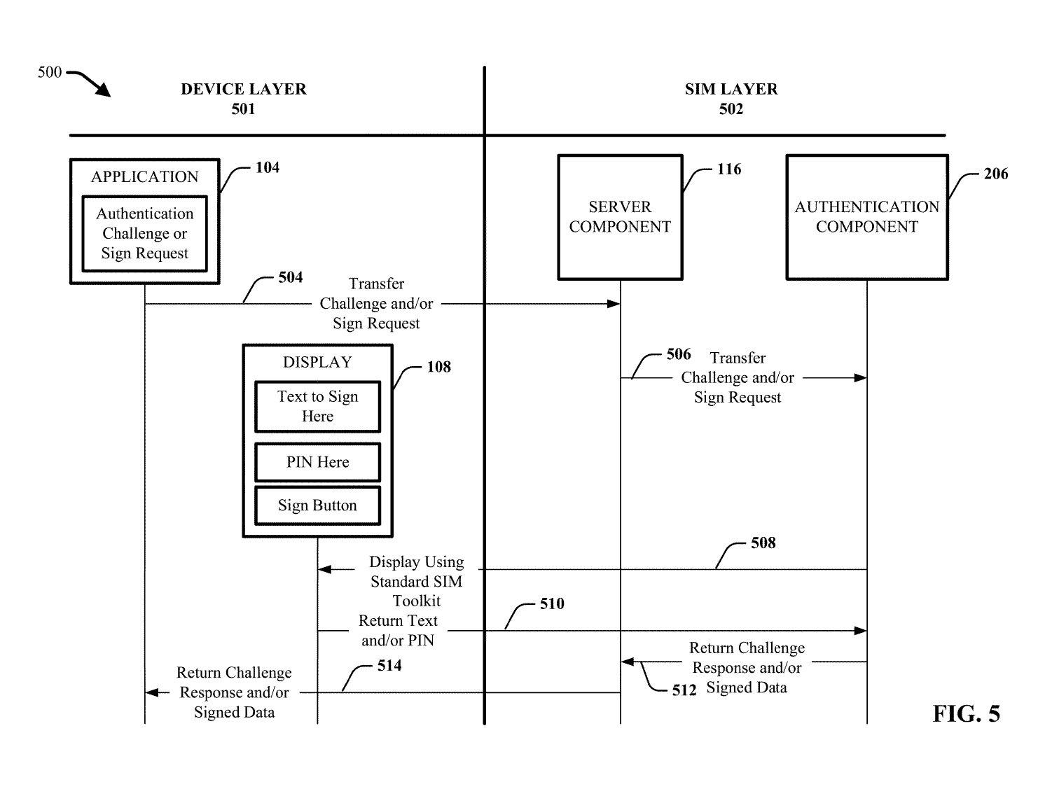

Turning now to FIG. 5, presented is a diagram demonstrating a process 500 of user authentication by an application of a mobile device at the mobile device (e.g., internally to a device and without communication to one or more external servers). In particular, as seen in FIG. 5, process 500 is implemented within a device layer 501 and a SIM layer 502. The SIM layer 502 represents acts performed at or by a SIM device 114 inserted into a mobile device 102. The device layer 501 represents acts performed at or by the mobile device 102 or application of the mobile device 102 employing the SIM device 114. The device layer 501 includes a mobile device application 104 and a mobile device display 108. The SIM layer 502 includes a server component 116 and an authentication component 206. Although not shown, it should be appreciated that user authentication is stored in memory of the SIM device 114 and thus associated with the SIM layer. The authentication information is accessed by the authentication component 206. Repetitive description of like elements employed in respective embodiments of devices and SIM devices described herein are omitted for sake of brevity.

Process 500 begins at the device layer 501 where an application 104 of a device 102 having a SIM card 114 communicatively coupled thereto, receives or generates an authentication request and/or a sign request. At 504, the application 104 transfers the challenge request and/or the sign request to server component 116 of the SIM layer 502. In some aspects, where the request includes a request to digitally sign data, the application can also transfer the data to be signed to the server component 116. As discussed supra, an application 104 communicates information to and from the server component 116 of the SIM device 114 using a browser of a LAN. The challenge request and/or sign request is therefore communicated between the application 104 and the server component 116 using HTTP. At 506, the server component transfers the challenge request and/or sign request (and associated data when a sign request) to the authentication component 206 of the SIM device. In an aspect, in response to receipt of the challenge request and/or the sign request, the authentication component can jump to step 512 and merely return the requested information to the server component as a challenge response and/or signed data. The authentication component can retrieve the requested information from memory of the SIM device 114.

However, in another aspect, a challenge and/or sign request received by the authentication component 206 can request that a user provide additional user identification input prior to allowing the authentication component to retrieve the requested information from memory of the SIM device. According to this aspect, at 508 the authentication component 206 can present a user, via display 108 with a prompt requiring a user to input his or her PIN number in association with a challenge request and/or a sign request (e.g., using standard SIM toolkit methods). The prompt can further present the user with text associated with a sign request and a sign button for the user to select as a command to sign the text. A user can then input his or her PIN number and select the sign button. The input information is sent back to the authentication component 206 for verification. If the input PIN number matches the PIN number for the user stored in memory at the SIM device, the authentication component 206 proceeds to return a challenge response and/or signed data to the application at 512. For example, the authentication component 206 can return the user's digital certificate or sign the data associated with a sign request with the user's private key stored at the SIM device 114. The authentication component 206 returns a challenge response and/or signed data to the server component at 512. The server component then returns the challenge response and/or signed data to the application 104 over the LAN using HTTP.

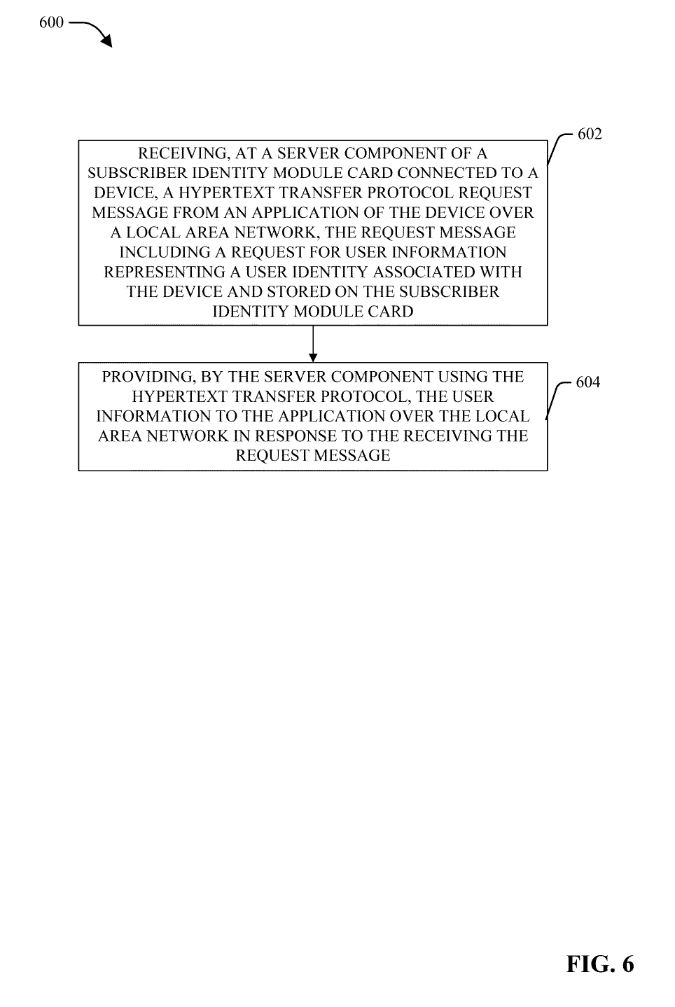

In view of the example systems and/or devices described herein, example methods that can be implemented in accordance with the disclosed subject matter can be further appreciated with reference to flowcharts in FIGS. 6-9. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 6 illustrates a flow chart of an example method 600 for retrieving, over a local area network (LAN), private user information from a SIM card communicatively coupled to a device using an application of the device. At 602, a server component of a subscriber identity module card connected to a device, receives from an application of the device, a hypertext transfer protocol request message over a local area network. The request message includes a request for user information representing a user identity associated with the device and stored on the subscriber identity module card. At 604. the server component provides the user information to the application over the local area network using the hypertext transfer protocol in response to receipt of the request message.

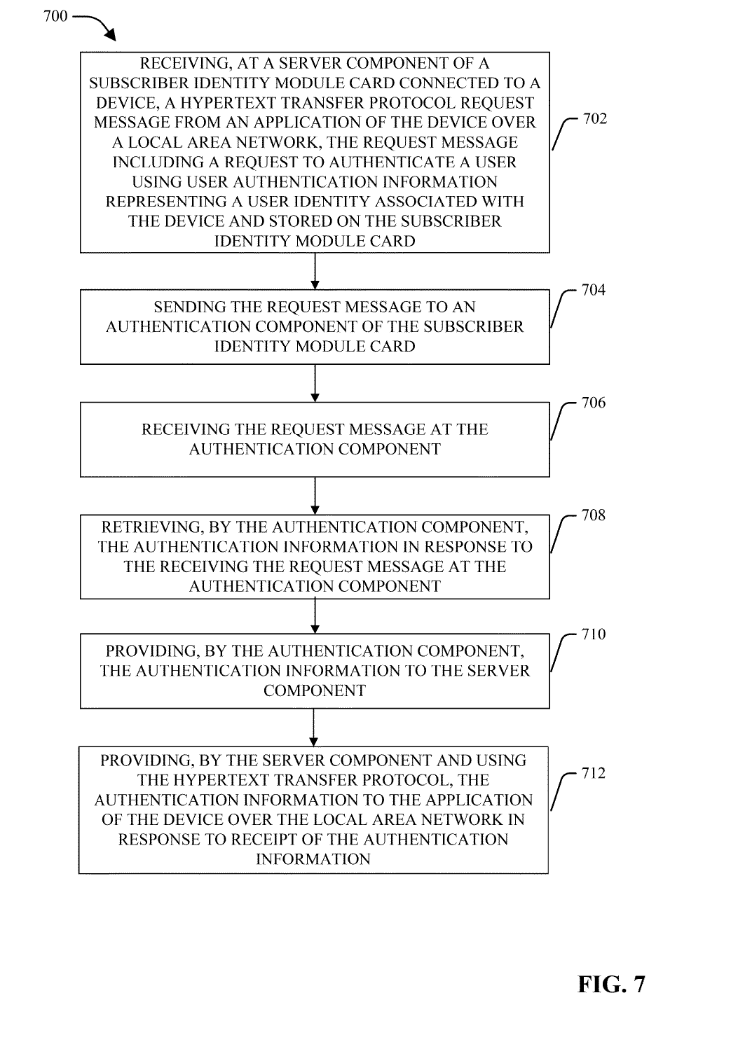

Referring next to FIG. 7, depicted is another flow chart of an example method 700 for retrieving, over a local area network (LAN), private user information from a SIM card communicatively coupled to a device using an application of the device. At 702, a server component of a subscriber identity module card connected to a device, receives from an application of the device, a hypertext transfer protocol request message over a local area network. The request message includes a request to authenticate a user using user authentication information representing a user identity associated with the device and stored on the subscriber identity module card. At 704. the server component sends the request message to an authentication component of the subscriber identity module card. At 706, the request message is received at the authentication component. At 708, in response to receipt of the request message, the authentication component retrieves the information from memory of the SIM card. At 710, the authentication component provides the authentication information to the server component. At 712, in response to receipt of the authentication information, the server component provides the authentication information, using HTTP, to the application of the device over the LAN.

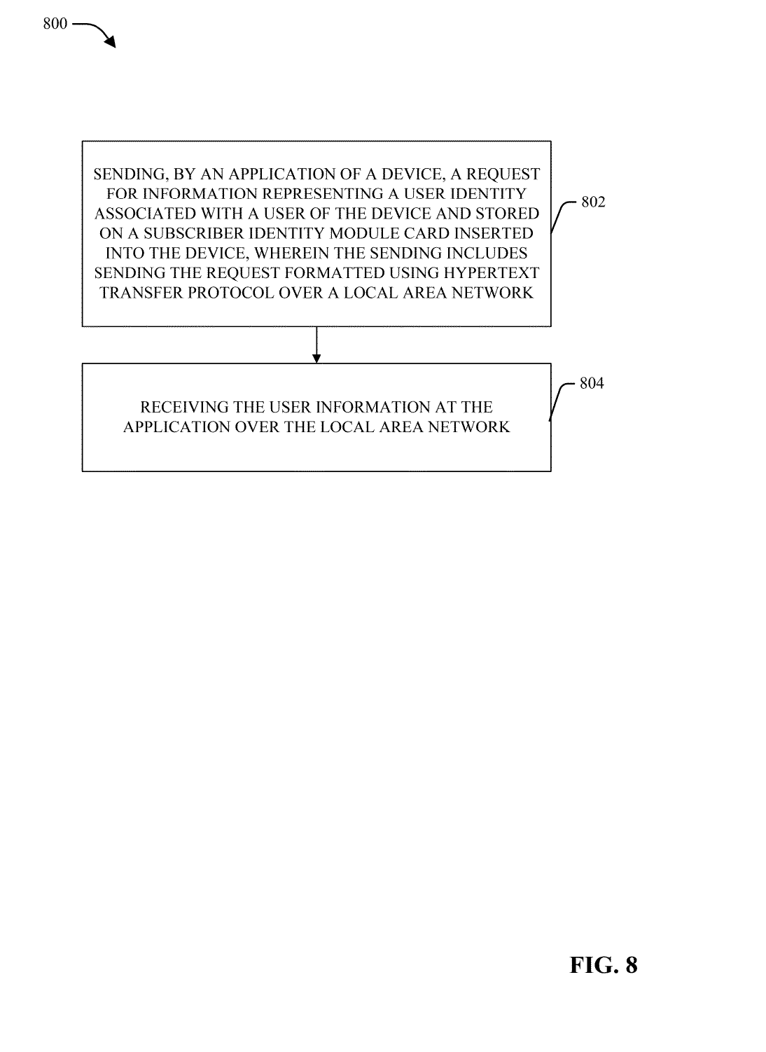

FIG. 8 presents another flow chart of an example method 800 for retrieving, over a local area network (LAN), private user information from a SIM card communicatively coupled to a device using an application of the device. At 802, a request for information representing a user identity associated with a user of a device and stored on a SIM device inserted into the device is sent by an application of the device. The application sends the request message to using HTTP over a LAN to a web server component provided on the SIM device. At 804, the application receives the information over the LAN from the web server component of the SIM device.

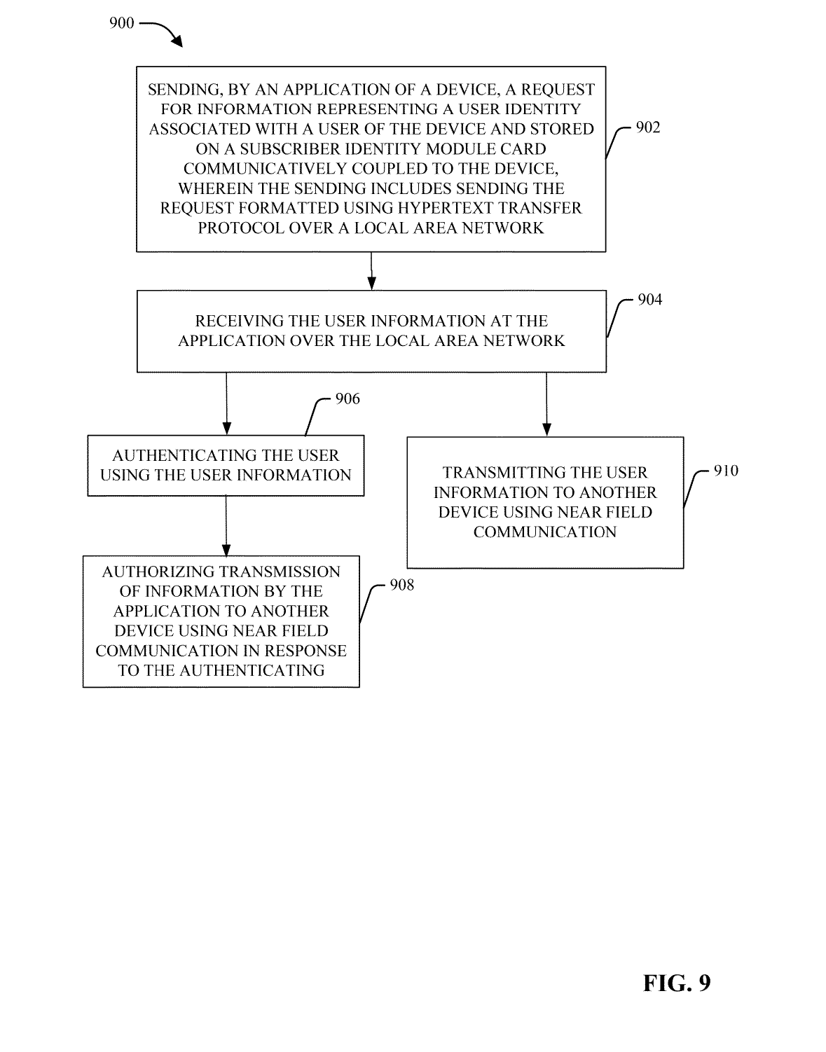

FIG. 9 presents another flow chart of an example method 900 for retrieving, over a local area network (LAN), private user information from a SIM card communicatively coupled to a device using an application of the device. At 902, a request for information representing a user identity associated with a user of a device and stored on a SIM device inserted into the device is sent by an application of the device. The application sends the request message to using HTTP over a LAN to a web server component provided on the SIM device. At 904, the application receives the information over the LAN from the web server component of the SIM device. After receipt of the user information by the application, the application can perform various acts depending on function of the application and the purpose of the request. For example, in one aspect, at 906, the application can authenticate a user using the user information. In response, to authentication, at 908, the application can further authorize transmission of information by the device to another device using NFC. In another example, after receiving the user information at the application, the application transmits the user information to another device using NFC. According to this aspect, the application can include an NFDT component 306.

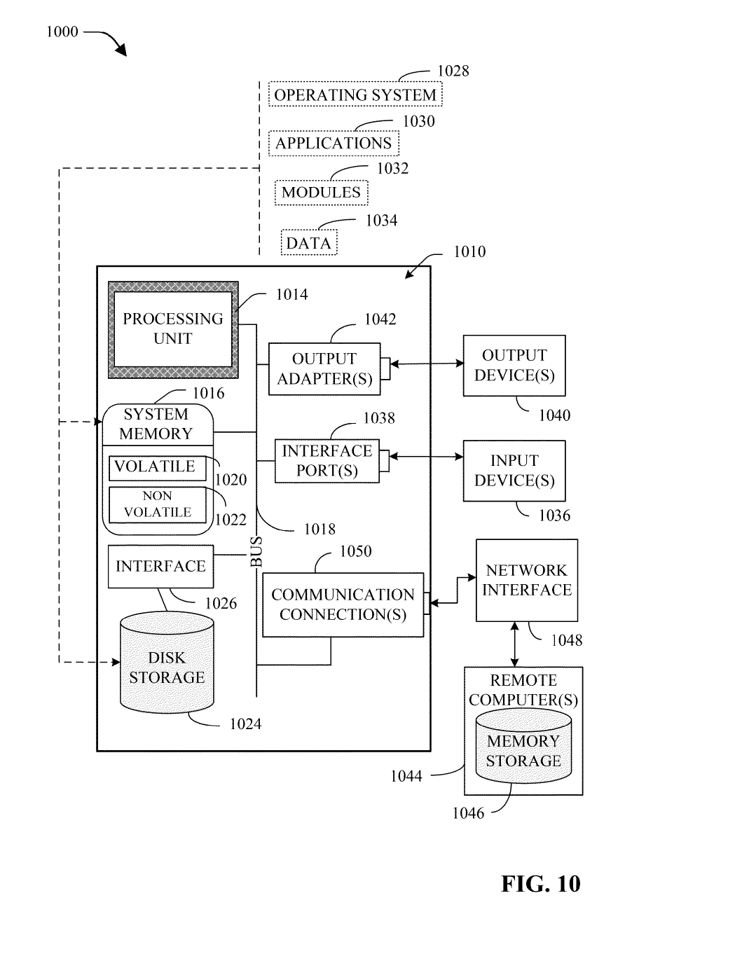

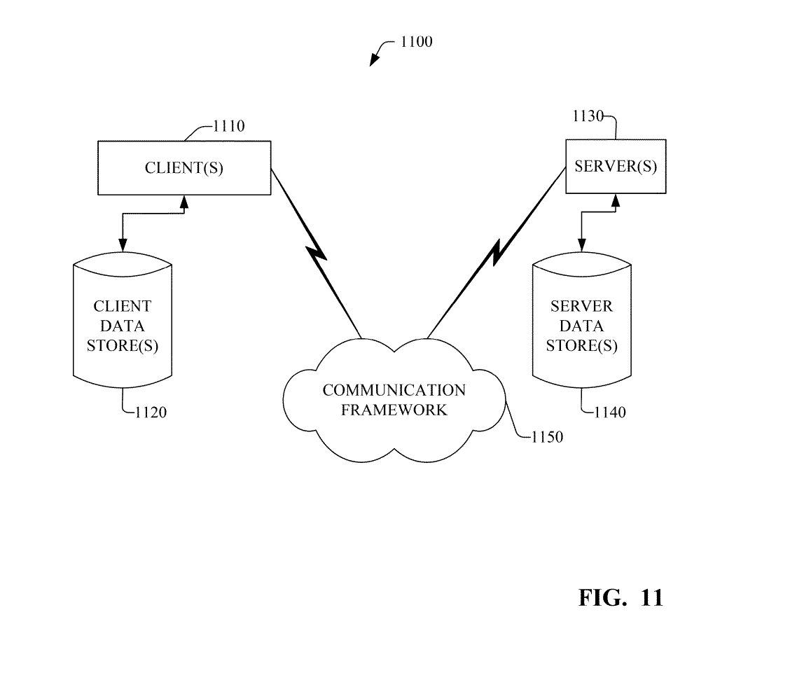

subject matter, FIGS. 10 and 11 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that this disclosure also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone, electronic tablets or pads, etc.), microprocessor-based or programmable consumer or industrial electronics, and the like. The illustrated aspects may also be practiced in distributed computing environments where tasks are performed by remote processing devices that are linked through a communications network. However, some, if not all aspects of this disclosure can be practiced on stand-alone computers. In a distributed computing environment, program modules may be located in both local and remote memory storage devices.

With reference to FIG. 12, a suitable environment 1200 for implementing various aspects of this disclosure includes a computer 1212. The computer 1212 includes a processing unit 1214, a system memory 1216, and a system bus 1218. It is to be appreciated that the computer 1212 can be used in connection with implementing one or more of the systems or components shown and described in connection with FIGS. 1-7, or otherwise described herein. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1010, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM)). Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1010 also includes removable/non-removable, volatile/non-volatile computer storage media. FIG. 10 illustrates, for example, a disk storage 1024. Disk storage 1024 includes, but is not limited to, devices like a magnetic disk drive, floppy disk drive, tape drive, Jaz drive, Zip drive, LS-100 drive, flash memory card, or memory stick. The disk storage 1024 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used, such as interface 1026.

FIG. 10 also depicts software that acts as an intermediary between users and the basic computer resources described in the suitable operating environment 1000. Such software includes, for example, an operating system 1028. Operating system 1028, which can be stored on disk storage 1024, acts to control and allocate resources of the computer system 1010. System applications 1030 take advantage of the management of resources by operating system 1028 through program modules 1032 and program data 1034 stored, e.g., in system memory 1016 or on disk storage 1024. It is to be appreciated that this disclosure can be implemented with various operating systems or combinations of operating systems.

A user enters commands or information into the computer 1010 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1010, and to output information from computer 1010 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1010 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1010. For purposes of brevity, only a memory storage device 1046 is illustrated with remote computer(s) 1044. Remote computer(s) 1044 is logically connected to computer 1010 through a network interface 1048 and then physically connected via communication connection 1050. Network interface 1048 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1010, it can also be external to computer 1010. The hardware/software necessary for connection to the network interface 1048 includes, for exemplary purposes only, internal and external technologies such as, modems including regular telephone grade modems, cable modems and DSL modems, ISDN adapters, and Ethernet cards.

FIG. 11 is a schematic block diagram of a sample-computing environment 1100 (e.g., computing system) with which the subject matter of this disclosure can interact. The system 1100 includes one or more client(s) 1110. The client(s) 1110 can be hardware and/or software (e.g., threads, processes, computing devices). The system 1100 also includes one or more server(s) 1130. Thus, system 1100 can correspond to a two-tier client server model or a multi-tier model (e.g., client, middle tier server, data server), amongst other models. The server(s) 1130 can also be hardware and/or software (e.g., threads, processes, computing devices). The servers 1130 can house threads to perform transformations by employing this disclosure, for example. One possible communication between a client 1110 and a server 1130 may be in the form of a data packet transmitted between two or more computer processes.

The system 1100 includes a communication framework 1150 that can be employed to facilitate communications between the client(s) 1110 and the server(s) 1130. The client(s) 1110 are operatively connected to one or more client data store(s) 1120 that can be employed to store information local to the client(s) 1110. Similarly, the server(s) 1130 are operatively connected to one or more server data store(s) 1140 that can be employed to store information local to the servers 1130.

It is to be noted that aspects, features, and/or advantages of the disclosed subject matter can be exploited in substantially any wireless telecommunication or radio technology, e.g., Wi-Fi; Bluetooth; Worldwide Interoperability for Microwave Access (WiMAX); Enhanced General Packet Radio Service (Enhanced GPRS); Third Generation Partnership Project (3GPP) Long Term Evolution (LTE); Third Generation Partnership Project 2 (3GPP2) Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); GSM (Global System for Mobile Communications) EDGE (Enhanced Data Rates for GSM Evolution) Radio Access Network (GERAN); UMTS Terrestrial Radio Access Network (UTRAN); LTE Advanced (LTE-A); etc. Additionally, some or all of the aspects described herein can be exploited in legacy telecommunication technologies, e.g., GSM. In addition, mobile as well non-mobile networks (e.g., the Internet, data service network such as Internet protocol television (IPTV), etc.) can exploit aspects or features described herein.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and memory devices comprising volatile memory and/or non-volatile memory (e.g., flash memory devices, such as, for example, card, stick, key drive, etc.), or the like. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions, wherein the processor can directly perform operations, and/or the processor can indirectly perform operations, for example, by directing or controlling one or more other components to perform operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component”, “system”, “platform”, “framework”, “layer”, “interface”, “agent”, and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment” (UE), “mobile station,” “mobile,” “wireless device,” “wireless communication device,” “subscriber station,” “subscriber equipment,” “access terminal,” “terminal,” “handset,” and similar terminology are used herein to refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point” (AP), “base station,” “Node B,” “Evolved Node B” (eNode B or eNB), “Home Node B” (HNB), “home access point” (HAP), and the like are utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows.

Furthermore, the terms “user,” “subscriber,” “customer,” “consumer,” “owner,” “agent,” and the like are employed interchangeably throughout the subject specification, unless context warrants particular distinction(s) among the terms. It should be appreciated that such terms can refer to human entities or automated components supported through artificial intelligence (e.g., a capacity to make inference based on complex mathematical formalisms), which can provide simulated vision, sound recognition and so forth.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be appreciated and understood that components (e.g., communication device, UE, AP, communication network, application, transition management component, etc.), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A subscriber identity module device, comprising:
at least one memory to store computer executable components and user information representing a user identity associated with a device with a subscriber identity module interface with which the subscriber identity module device is configured to be employed, wherein the computer executable components comprise:
a local server component configured to, as facilitated by a processor of the device communicatively coupled to the at least one memory, at least:
receive a hypertext transfer protocol request message for the user information from an application of the device over a local area network, and
provide the user information to the application over the local area network using the hypertext transfer protocol in response to receipt of the hypertext transfer protocol request message.

2. The subscriber identity module device of claim 1, wherein the user information comprises authentication information and the hypertext transfer protocol request message includes a request to authenticate the user identity using the authentication information, and wherein the computer executable components further comprise:
an authentication component, wherein the local server component is configured to transfer the hypertext transfer protocol request message to the authentication component based on the request to authenticate the user, and wherein the authentication component is configured to receive the hypertext transfer protocol request message from the local server component, retrieve the authentication information in response to receipt of the hypertext transfer protocol request message, and provide the authentication information to the local server component, wherein the local server component is configured to provide the authentication information to the application of the device in response to receipt of the authentication information.

3. The subscriber identity module device of claim 2, wherein the authentication component is further configured to request personal identification information associated with the user identity and defined in the memory in response to receipt of the hypertext transfer protocol request message and prior to providing the authentication information to the local server component.

4. The subscriber identity module device of claim 3, wherein the authentication component is configured to receive input of personal identification information, determine that the input of personal identification information matches the personal identification information associated with the user identity defined in the memory, and in response, provide the authentication information to the local server component.

5. The subscriber identity module device of claim 3, wherein the local server component is configured to receive other personal identification information from another device via a near field data transfer component and provide the other personal identification information to the authentication component, wherein the authentication component is configured to determine that the other personal identification matches the personal identification information associated with the user identity defined in the memory, and in response, provide the authentication information to the local server component.

6. The subscriber identity module device of claim 5, wherein the near field data transfer component is disposed on the subscriber identity module device and includes a radio frequency transceiver configured to receive the personal identification information.

7. The subscriber identity module device of claim 5, wherein the near field data transfer component is disposed on the device and includes a radio frequency transceiver configured to receive the personal identification information.

8. The subscriber identity module device of claim 2, wherein the authentication information includes a digital certificate and the hypertext transfer protocol request message includes a request to electrically sign data with the digital certificate, wherein the local server component is configured to send the data and the hypertext transfer protocol request message to the authentication component, wherein the authentication component is configured to attach the digital certificate to the data in response to receipt of the data and the hypertext transfer protocol request message, and wherein the local server component is configured to provide the data with the attached digital certificate to the application of the device.

9. The subscriber identity module device of claim 2, wherein the hypertext transfer protocol request message includes a request to authorize access to the application of the device over an external network using the authentication information.

10. The subscriber identity module device of claim 2, wherein the authentication information includes a private key associated with the user identity and the hypertext transfer protocol request message includes a request to authenticate the user identity with the private key, wherein the local server component is configured to send the hypertext transfer protocol request message to the authentication component, wherein the authentication component is configured to retrieve the private key in response to the hypertext transfer protocol request message, and wherein the local server component is configured to provide the private key to the application of the device.

11. The subscriber identity module device of claim 1, wherein the user information comprises user account information and the hypertext transfer protocol request message includes a request for the user account information, wherein the local server component is configured to provide the user account information to the application of the device in response to receipt of the hypertext transfer protocol request message.

12. The subscriber identity module device of claim 11, wherein the local server component is configured to provide the user account information to the application of the device in a format that enables modification of the user account information, and wherein the local server component is configured to receive a hypertext transfer protocol message over the local area network with a modification to the user account information and issue the modification to the user account information in the memory.

13. The subscriber identity module device of claim 1, wherein the local server component is further configured to receive a hypertext transfer protocol hypertext transfer protocol request message for the information from another device via a near field data transfer component over a local area network and provide the information to the near field data transfer component over the local area network in response to receipt of the hypertext transfer protocol request message using hypertext transfer protocol, wherein the near field data transfer component is configured to provide the information to the other device.

14. The subscriber identity module device of claim 13, wherein the user information comprises user authentication information and the hypertext transfer protocol request message includes a request to authenticate the user identity by an application of the other device using the user authentication information, the subscriber identity module device further comprising:
an authentication component, wherein the local server component is configured to transfer the hypertext transfer protocol request message to the authentication component based on the request to authenticate the user identity, wherein the authentication component is configured to receive the hypertext transfer protocol request message from the local server component, retrieve the authentication information in response to receipt of the hypertext transfer protocol request message, and provide the authentication information to the local server component, and wherein the local server component is configured to provide the authentication information to the near field data transfer component in response to receipt of the authentication information.

15. The subscriber identity module device of claim 13, wherein the near field data transfer component is disposed on a circuit of the device and includes a radio frequency transceiver configured to transmit the information to the other device using a near field communication.

16. The subscriber identity module device of claim 1, wherein the local server component is configured to receive the hypertext transfer protocol request message from the application of the device using a browser of the device and provide the user information to the application of the device using the browser of the device.

17. The subscriber identity module device of claim 1, wherein the device is a mobile telephone.

18. A method, comprising:
employing at least one processor to facilitate executing computer executable instructions from at least one computer readable storage device to perform operations comprising:
receiving, at a local server component of a subscriber identity module card connected to a device, a hypertext transfer protocol request message from an application of the device over a local area network, the hypertext transfer protocol request message including a request for user information representing a user identity associated with the device and stored on the subscriber identity module card; and
providing, by the local server component using the hypertext transfer protocol, the user information to the application over the local area network in response to the receiving the hypertext transfer protocol request message.

19. The method of claim 18, wherein the user information comprises user authentication information and the hypertext transfer protocol request message includes a request to authenticate the user identity using the user authentication information, the method further comprising:
sending the hypertext transfer protocol request message to an authentication component of the subscriber identity module card;
receiving the hypertext transfer protocol request message at the authentication component;
retrieving, by the authentication component, the user authentication information in response to the receiving the hypertext transfer protocol request message at the authentication component;
providing, by the authentication component, the user authentication information to the local server component; and
providing, by the local server component, the user authentication information to the application of the device in response to receipt of the user authentication information.

20. The method of claim 19, further comprising, prior to the retrieving the user authentication information by the authentication component and in response to the receiving the hypertext transfer protocol request message at the authentication component:
requesting, by the authentication component, personal identification information associated with the user identity.

21. The method of claim 20, further comprising, in response to the requesting:
receiving, at the authentication component, input of personal identification information;
determining, by the authentication component, that the input of personal identification information matches the personal identification information associated with the user identity as stored in memory of the subscriber identity module card, and in response to the determining;
providing, by the authentication component, the user authentication information to the local server component.

22. The method of claim 20, further comprising, in response to the requesting:
receiving, by the local server component, other personal identification information from a near field data transfer component, the other personal identification information having been transmitted to the near field data transfer component by another device;
providing, by the local server component, the other personal identification information to the authentication component;
determining, by the authentication component, that the other personal identification information matches the personal identification information associated with the user identity as stored in memory of the subscriber identity module card, and in response to the determining;
providing, by the authentication component, the user authentication information to the local server component.

23. The method of claim 22, wherein the near field data transfer component is disposed on the subscriber identity module card, the method further comprising:
receiving the other personal identification information from the other device via a radio frequency transceiver of the near field data transfer component using near field communication.

24. The method of claim 19, wherein the authentication information includes a digital certificate and the hypertext transfer protocol request message includes a request to sign data with the digital certificate, the method further comprising:
sending by the local server component, the data and the hypertext transfer protocol request message to the authentication component;
attaching, by the authentication component, the digital certificate to the data in response to receipt of the data and the hypertext transfer protocol request message to generate signed data; and
sending, by the local server component, the signed data to the application of the device over the local area network using hypertext transfer protocol.

25. The method of claim 19, wherein the hypertext transfer protocol request message includes a request to authorize access to the application of the device over an external network using the user authentication information.

26. The method of claim 18, wherein the hypertext transfer protocol request message includes a request to authorize, using the user information, transmission of data by the application of the device to another device using a near field communication.

27. The method of claim 19, wherein the user information comprises user account information and the hypertext transfer protocol request message includes a request for the user account information, the method further comprising:
providing, by the local server component, the user account information to the application of the device.

28. The method of claim 27, wherein the providing the user account information to the application of the device includes providing the account information to the application of the device in a format that allows modification of the account information, the method further comprising:
receiving a hypertext transfer protocol message over the local area network with a modification to the user account information; and
issuing the modification to the user account information at the subscriber identity module card.

29. The method of claim 19, further comprising:
receiving, by the local server component, the hypertext transfer protocol request message for the user information from a near field data transfer component of the device; and
in response to an indication that the user information is authenticated, providing the user information to the near field data transfer component.

30. A device, comprising:
an interface that receives a subscriber identity module card storing user information representing a user identity associated with a user of the device and comprising a local server component configured to provide the information over a local area network using hypertext transfer protocol;
a memory having computer executable components stored thereon, and configured to store information associated with a user of a device in which the integrated circuit card is employed, the information comprising private information associated with the user; and
a processor communicatively coupled to the memory, the processor configured to facilitate execution of the computer executable components, the computer executable components, comprising:
a browser configured to access data using hypertext transfer protocol; and
an application configured to employ the browser to receive the user information from the local server component over the local area network.

31. The device of claim 30, wherein the information comprises user authentication information and the application is configured to request the user authentication information and receive the user authentication information in response to a request to authenticate the user.

32. The device of claim 31, wherein the request to authenticate the user is a request to authenticate the user at an external system capable of being accessed by the application via a network, wherein the application is configured to submit the user authentication information to the external system via the network.

33. The device of claim 31, further comprising a near field data transfer component configured to receive personal identification information from another device and provide the personal identification information to the local server component, wherein the application is configured to receive the user authentication information after the local server component receives the personal identification information.

34. The device of claim 31, further comprising a near field data transfer component configured to receive the authentication information from the local server component via the browser and transmit the authentication information to another device using near field communication.

35. The device of claim 30, wherein the information comprises user account information, the device further comprising a display configured to display the user account information.

36. The device of claim 35, wherein the application is configured to allow a modification to the user account information, accept the modification to the user account information and send the modification to the to the subscriber identity module using the browser.

37. The device of claim 30, wherein the device is a mobile telephone.

38. A tangible computer-readable storage medium comprising computer-readable instructions that, in response to execution, cause a computing system to perform operations, comprising:
sending, by an application of a device, a request for information representing a user identity associated with a user of the device and stored on a subscriber identity module card communicatively coupled to the device, wherein the sending includes sending the request formatted using hypertext transfer protocol over a local area network; and
receiving the user information at the application over the local area network.

39. The tangible computer-readable storage medium of claim 38, wherein the request includes a request to authenticate the user using the information, the operations further comprising, authenticating the user using the information.

40. The tangible computer-readable storage medium of claim 38, wherein the information includes a digital certificate assigned to the user.

41. The tangible computer-readable storage medium of claim 40, wherein the request includes a request to sign data using the digital certificate, the operations further comprising:
sending data for signing with the request;
receiving the data having the digital certificate attached; and
employing the data having the digital certificate attached as a digital signature for the user.

42. The tangible computer-readable storage medium of claim 38, the operations further comprising submitting the information to an external system over an external network and receiving access to the external system in response to the submitting.

43. The tangible computer-readable storage medium of claim 39, the operations further comprising:
authorizing transmission of data from the device to another device using near field communication in response to the authenticating.
